(19) United States
(12) Patent Application Publication
(10) Pub. No.: US 2014/0095860 A1
(43) Pub. Date: Apr. 3, 2014

(54) ARCHITECTURE FOR CLOUD COMPUTING USING ORDER PRESERVING ENCRYPTION

(71) Applicants: Alcatel-Lucent USA Inc., Murray Hill, NJ (US); Alcatel Lucent, Paris (FR)

(72) Inventors: Abdullatif Shikfa, Villebon-sur-Yvette (FR); Vladimir Kolesnikov, Jersey City, NJ (US)

(21) Appl. No.: 13/630,460

(22) Filed: Sep. 28, 2012

(51) Int. Cl. H04L 9/00; H04L 9/30

(52) U.S. Cl. 713/150

(57) ABSTRACT

A method for providing enhanced security in cloud computing architecture by managing the types of interaction a server should be allowed, thus preventing decryption of private data. A client may encrypt data using an order preserving encryption (OPE) algorithm. One application of the method and system is a browser-based webmail application where a client may receive email from one or more servers then store the received email that has been associated with OPE data, on a separate server that is not used to send or receive email.

This invention relates generally to providing data privacy through encryption while still allowing access to the data in a client-server or cloud computing system.

### BACKGROUND

Cloud computing is a type of computer system where computing resources, both hardware and software, are delivered as a service over a network. Typically, the cloud is a collection of storage devices, servers and other elements that are accessed by clients to perform computing tasks, where the clients' primarily display data while most of the processing and storage occurs in the cloud. A similar system is the client-server model which differs mainly in that more of the processing and data storage takes place on the client.

The value of many cloud services lies in the ability to operate on client's data. Typical examples include data storage, webmail service, advertising, geolocation services, etc. However, the need to search and perform computation on client's data (e.g., files, email, and location) is often at odds with clients' data privacy needs. Consider the case of sortable data, which is typically data which can be encoded or mapped to numeric values. A client having numeric data that it wants to store in the cloud (or more generally, any outsourced server) may not fully trust the cloud operator and hence wants to encrypt the numeric data. However, the client also wants to access some of these data and perform range queries on it. Reconciling these contradictory requirements, and achieving computation on encrypted data, is an important research and engineering problem, whose efficient solution would have a far-reaching business impact.

A generic breakthrough theoretical approach, fully homomorphic encryption, or FHE, while general, is currently inefficient, and seems unlikely to become truly practical in the foreseeable future. Although significant effort is underway in the theoretical community to improve the performance of FHE, it seems unlikely that fully homomorphic encryption would soon approach the efficiency of current public-key encryption schemes. Intuitively, this is because a fully homomorphic cryptosystem must provide the same strong security guarantees, while, at the same time, possessing extra algebraic structure to allow for homomorphic operations. The extra structure weakens security, and countermeasures (costing performance) are necessary. Further, even performance equivalent to that of a “regular” public-key encryption scheme, such as RSA, is unsatisfactory in most scenarios. This is because this generic approach of computing under encryption requires performing a public-key operation for each trivial step of the client-server computation, such as addition.

Similarly, a generic approach based on Garbled Circuits is also inapplicable in a number of cloud settings, where the computed functions are large. Despite relying on symmetric encryption and hence being dramatically more efficient than FHE, the Garbled Circuit approach also suffers from overhead, both in computation and communication, linear in the size of the computed function.

On the other hand, ad-hoc approaches, such as order-preserving encryption (OPE), provide solutions to a limited class of computations on encrypted data, such as evaluating encrypted range queries. (An OPE has the property that for any two messages m1 and m2, where m1<m2, it holds that OPE(m1)<OPE(m2)).

However, in contrast with “regular” encryption schemes, OPE ciphertexts necessarily reveal significant amount of information about the plaintext they encrypt. For example, the magnitude of the OPE ciphertext allows to produce an estimate of the range of the corresponding plaintext. Worse, the estimate gets more precise, given additional ciphertexts. Worse yet, auxiliary information available to the adversary, such as plaintext/ciphertext pairs (especially if plaintexts are adversarily chosen) and knowledge of plaintext distribution, allows the adversary to narrow the estimates and eventually (actually, quite quickly) decrypt protected information. The type and amount of available auxiliary information depends on an application, and is very hard to formalize and analyze in general.

Thus, a need exists for a computing system that provides additional security for data that is encrypted in such a way that it may still be searched.

### SUMMARY

The invention in one implementation encompasses a method and system for enhancing security in a cloud computing system by restricting the types of interaction a server should be allowed, thus preventing decryption of private data.

In one embodiment, a networked system having at least one server coupling a plurality of clients provides secure, searchable data storage on the network through the steps of receiving, by a client, an encrypted data file from a server associated with a first provider, encrypting, by the client, at least one selected characteristic associated with the data file using an algorithm which allows computation on encrypted data and storing, by the client, the encrypted data file on a different server associated with a second provider that does not share stored data files with the first provider.

In another embodiment, a cloud computing system having a plurality of servers for controlling the exchange of email between clients over a network, provides secure, searchable storage of email on the network through the steps of receiving, by a client, an encrypted email from a reception account hosted on a server associated with a first provider, encrypting, by the client, at least one selected characteristic associated with the email using an algorithm which allows computation on encrypted data and storing, by the client, the encrypted email on a repository account hosted on a different server associated with a second provider that does not share stored data with the first provider.

Some embodiments of the above methods further include wherein the server associated with a first provider hosts a reception account used to relay public-key encrypted email from senders of email to the client.

Some embodiments of the above methods further include the step of verifying, by the client, a signature in each email from a reception account, the signature requiring a private key of the sender of the email.

Some embodiments of the above methods further include wherein the client receives email from a plurality of reception accounts hosted on one or more servers.

Some embodiments of the above methods further include wherein during the encrypting step, the client uses an order preserving encryption (OPE) algorithm.

Some embodiments of the above methods further include wherein client maintains a list of trusted sources of email and does not process email originating from a server hosting a reception account.

Some embodiments of the above methods further include wherein one or more servers may provide reception accounts for the client.

Some embodiments of the above methods further include wherein the client does not process emails to or from the repository account.

Some embodiments of the above methods further include wherein the clients access the servers associated with the first and second providers by using a web browser application.

Some embodiments of the above methods further include wherein the selected characteristic is represented by a number of bits and the OPE algorithm is randomized by adding n random bits to the number of bits of the selected characteristic before executing the OPE algorithm.

Some embodiments of the above methods further include wherein the OPE algorithm is randomized by computing OPE of x and x+1 and returning a value chosen at random at each execution in the interval [OPE(x), OPE(x+1)[ as the output.

In another embodiment, there is provided a computer program product comprising a computer-readable signal-bearing media having computer usable program code for performing the steps of receiving an encrypted data file from a server associated with a first provider, encrypting at least one selected characteristic of the data file using an algorithm which allows computation on encrypted data and storing the encrypted data file on a different server associated with a second provider that does not share stored data files with the first provider.

Some of the embodiments of the computer program product further include wherein the server associated with the first provider is a webmail server and the data file represents an email.

Some of the embodiments of the computer program product further include wherein the server associated with a first provider hosts a reception account used to relay public-key encrypted email from senders of email to the client.

Some of the embodiments of the computer program product further include the step of verifying, by the client, a signature in each email from a reception account, the signature comprising a private key of the sender of the email.

Some of the embodiments of the computer program product further include wherein the client receives email from a plurality of reception accounts hosted on one or more servers.

Some of the embodiments of the computer program product further include wherein the encrypting step uses an order preserving encryption (OPE) algorithm.

### DESCRIPTION OF THE DRAWINGS

Features of example implementations of the invention will become apparent from the description, the claims, and the accompanying drawings in which:

FIG. 1 is a representation of a prior art mail server implementation in a cloud computing system.

FIG. 2 is a representation of a mail server implementation in a cloud computing system having restricted interactions between a client and a mail server.

FIG. 3 is a representation a mail server implementation in a cloud computing system where mail storage is separate from mail delivery.

FIG. 4 is an event trace diagram illustrating the method of operating the embodiments of FIGS. 2 and 3.

### DETAILED DESCRIPTION

Specific details regarding the implementation of OPE will now be discussed.

An order-preserving symmetric encryption (or OPE) scheme is a deterministic symmetric encryption scheme whose encryption algorithm produces ciphertexts that preserve numerical ordering of the plain texts.

Led D and R be finite ordered sets (considered as subsets of natural numbers for the sake of simplicity). OPE is an order preserving encryption scheme with plaintext space D, ciphertext space R and key space K, if for any choice of keys kεK and any choce of inputs x₁, x₂εD, the following holds:

x₁<x₂ [symbol] OPE(k, x₁)<OPE(k, x₂).

When the choice of keys is clear, OPE(k, x₁) may be written as OPE(x₁).

OPE is valuable for a variety of applications where security concerns may prevent sharing the data in plaintext. However, even the use of an ideal OPE implementation will not necessarily provide a secure application.

The appeal of order-preserving encryption is in its power to encrypt the data in a way that allows performing searches on it without possession of the secret key. Additionally, and in contrast with deterministic-encryption alternatives, the queries supported by OPE include not only equality searches (searching for a specific keyword) but also range queries, which is critical for a variety of applications. OPE can be viewed as a tool somewhat similar to fully homomorphic encryption, in that it can repeatedly operate on encrypted data. It is weaker than FHE, since the manipulation primitive is limited to equality checking and comparisons. Even more importantly, in contrast with FHE, a program evaluator knows the result of the comparisons, which leaks to him certain information. This information, aggregated over the life of the system, and especially, combined with possible externally available information, may reduce or even completely dismantle security provided by OPE. However, OPE offers truly practical efficiency, and is one of the very few available scalable crypto-computing tools.

As noted above, there are a number of applications which benefit from order preserving encryption. For example, one case is the need to perform privacy-preserving searches on multimedia. Visual features are extracted from the multimedia document, hierarchically clustered, and then assigned to a “visual word.” The entire document is then represented as an indexed list of keywords. For privacy protection, the word frequency values are encrypted with OPE, enabling a ranked search on the indexes. In another example, secure and efficient ranked keyword search over encrypted data stored in the cloud can be provided by applying OPE on certain relevance criteria such as keywords' frequencies. As a further example, privacy and confidentiality of health data can be protected using OPE to enable some operation on dates expressed in milliseconds without having to decrypt them first. All of these examples have the common feature that they target an outsourced computation or storage model, a key characteristic of cloud computing.

Another example of an application in which OPE is useful is email. It is noted that webmail is a term generally used when email is provided in a cloud computing system via a web browser application. For the purposes of this discussion, webmail and email are interchangable.

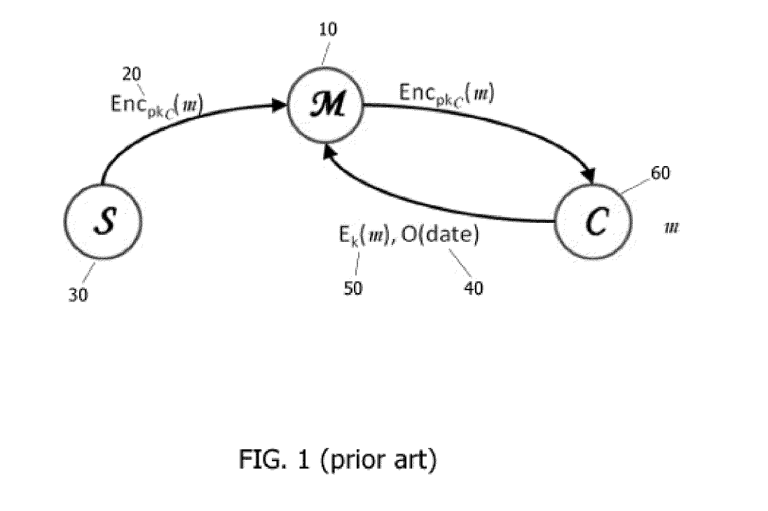

A prior art webmail application system is depicted in FIG. 1. A webmail application is provided as a service by a mail server 10. When a sender 30 wishes to send an email m to a client 60, sender 30 encrypts the message in an end-to-end fashion, so the server 10 cannot access its content. Most commonly, sender 30 relies on the use of a public-key infrastructure (PKI). With PKI, client 60 owns a public/private pair pk_{C}/sk_{C}, which is published through the PKI. Sender 30 encrypts the email m with client 60 public key pk_{C} resulting in Enc_{pkC}(m) 20. Upon receiving Enc_{pkC}(m) 20, mail server 10 forwards it to client 60. At this time, server 10 cannot infer anything about m, or modify it. With its private key sk_{C}, client 60 decrypts the message locally and retrieves m.

The main benefit of web-based email is its universal access. To take advantage of cloud-based availability, client 60 then stores m, re-encrypted with the symmetric key of client 60, at server 10 as Eₖ(m) 50. This encryption algorithm can simply be Advanced Encryption Standard (AES). However, the use of AES only does not allow the client 60 to take advantage of the essential services of server 10, such as mail sorting and classification. To reconcile security with functionality, client 60 uses OPE to encrypt and additionally send to server 10 certain fields, for example, the ones used to perform searches and range queries, such as the date as O(date) 40 of FIG. 1. Client 60 may also choose to include the time of the email m, or the name or domain of sender 30. As a result, server 10 cannot access the messages of client 60 but can reply to range queries on the fields encrypted with OPE.

In a real-world environment, it is fairly easy for server 10 to overcome the OPE encryption of client 60. For example, server 10 may be interested in data-mining the emails of client 60, and may even be interested in attacks against an individual client. Thus, server 10 may constitute a “semi-honest” adversary. This type of adversary is one who exactly follows the protocol specification, yet attempts to learn additional information by analyzing “everything he sees”, for example his input, randomness and the transcript of messages received during the execution. While the semi-honest adversary is far weaker than a malicious one, protection against only semi-honest adversaries is often sufficient for real-world applications. In other words, a semi-honest adversary is one who would prefer to maintain a good reputation and thus would only be willing to engage in security violation efforts that are difficult, if not impossible, to detect.

Two ways in which a semi-honest server 10 may choose to violate the security of an email system are known-plaintext attacks (KPA) and chosen-plaintext attacks (CPA). In a KPA, server 10 obtains samples of both a plaintext and its encrypted version, but has no control over which pairs are obtained. A CPA is similar to a KPA, except that server 10 may now choose plaintexts and obtain their encryptions. Unfortunately, in the prior art mail server system, OPE does not prevent either of these attacks.

For example, in the webmail application, it is rare for server 10 to have absolutely no information about the plaintext corresponding to an encrypted text. If server 10 has forwarded Enc_{pkC}(m) to client 60, it can certainly estimate, with reasonable confidence, the date/time or sender's name or domain that correspond with OPE. Thus, server 10 has a plaintext and its encrypted version for analysis.

Further server 10 may perform a CPA attack by pretending to be a legitimate sender and send client 60 an arbitrary message containing a specific plaintext x that server 10 wants encrypted with OPE. This is easily achieved by simply encrypting x with the public key pk_{C} of client 60, delivering this encryption as part of received mail, and receiving from client 60 OPEₖ(x) according to the protocol. This type of attack is relatively low-risk, since it is hard for client 60 to distinguish such emails from “regular” unsolicited email.

Server 10 may also perform a type of chosen-ciphertext attack (CCA). In the system of FIG. 1, the application run by client 60 (which is in possession of the secret key) automatically responds to encrypted mail delivered to it. It decrypts the messages and displays them for the user. Either the application or the user may take certain actions, visible to server 10 based on the content of the decrypted email fields. For example, the application may automatically notify the server of a decryption failure, or a sorting discrepancy, and the user may respond to an email. This information, collected by server 10, may help infer the plaintext content of the OPE encrypted data it received.

Finally, server 10 may have other information which may lead to exposure of client 60's data. For example, personal, group or statistical information available about a particular client helps predict the client's communication patterns, including dates and times, vocabulary used in emails, the circle of names of his correspondents, etc.

According to the present invention, the amount of usable auxiliary information is reduced so that attacks may be minimized and security of client data may be enhanced.

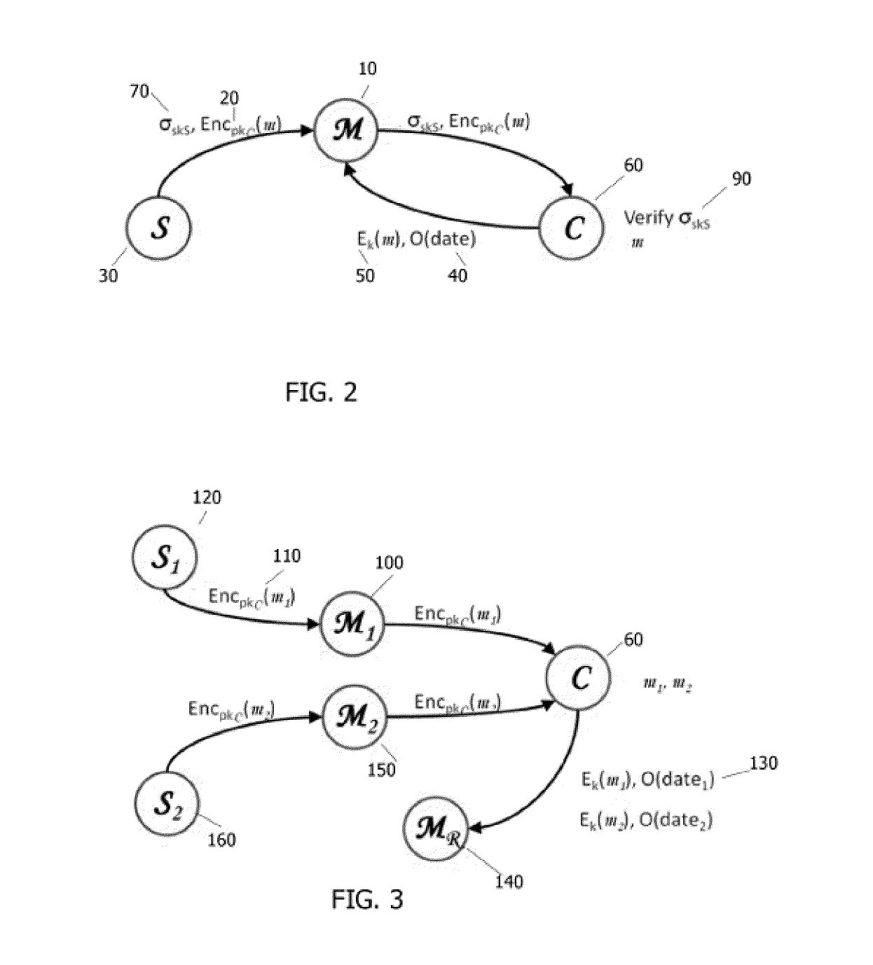

In a first embodiment, shown in FIG. 2, client 60 is only allowed to use OPE encryption with emails coming from trusted sources. This is achieved by adding a public-key-based signature authentication to each email. With a PKI intrastructure, sender 30 for FIG. 2 adds a signature σ_{skS} 70 to Enc_{pkC}(m) 20. Signature 70 has been generated with a private key sk_{S} of sender 30. When Enc_{pkC}(m) 40 is forwarded to client 60 by server 10, client 60 can verify σ_{skS} 70 at 90.

Even if a public key infrastructure is not available, public keys of known senders can be stored by client 60. This can take the form of adding a contact or a first message received from a particular sender to a table.

In another embodiment, enhanced data security in webmail systems using OPE can be provided by the architecture shown in FIG. 3. As shown in this figure, the roles of an email service are separated between independent mail servers. In the prior art system of FIG. 1, a single server 10 saw encrypted email that had plaintext headers, size, timestamps, etc. It also saw OPE encrypted fields when client 60 stored them at 50. The combination of these two roles allowed server 10 to associate plaintexts and ciphertexts, thus facilitating breaking the OPE encryption.

However, in the embodiment of the invention shown in FIG. 3, mail server 100 serves as relay for Enc_{pkC}(m₁) 110 from sender 120. Client 60 receives the forwarded email, encrypts it and generates the OPE encrypted fields at 130. Then, instead of returning data 130 to mail server 100, it is sent to a different storage service 140. Storage 140 can be any storage service that has appropriate user interface (UI) support.

In a preferred embodiment, storage 140 is provided by another mail server. The advantage of mail services over simple storage systems is that, not only do they offer a ubiquitous access to stored mail, but they also have a webmail-specific front-end with a UI to support sorting by fields, searching, importing mail archives (such as .pst archives), etc. Further, since OPE encryptions can be viewed, or at least encoded, as “regular” plaintext fields, such as timestamps, sender names, etc., the changes to support OPE encryption by existing webmail servers may be very minimal.

Thus, the roles of an email service are separated between a first email account provided by mail server 100 and a second email account provided by mail server 140. The first email account relays encrypted email and is known as the reception account while the second email account, known as the repository account, is used only as mail storage and UI interface, and will not receive or send any email directly. All direct email received for this account should be disregarded.

As shown in FIG. 3, a single repository account at mail server 140 may support multiple reception accounts. FIG. 3 depicts mails servers 100 and 150 as relaying email for two different reception accounts from sender 120 and sender 160. Sender 160 sends Enc_{pkC}(m₂) to client 60 via server 150. Multiple reception accounts could also be hosted on the same server. The architecture of FIG. 3 provides an added benefit in that a single repository account enables efficient searches across a plurality of reception accounts. As a further enhancement, client 60 may choose to upload mail in batches and pad the email fields as needed.

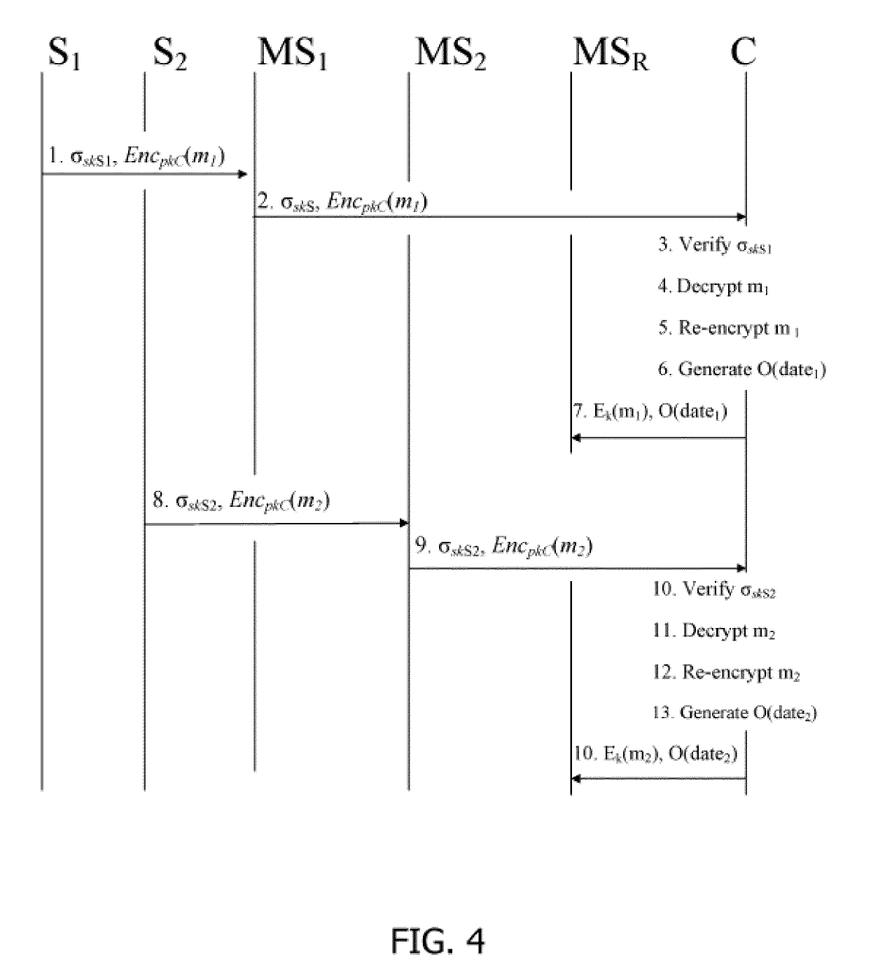

The method of the embodiments depicted in FIGS. 2 and 3 is shown in the event trace diagram of FIG. 4. In a first step, Sender S₁ generates it's signature encrypted with it's public key skS₁ as σ_{skS1} and also generates an email m₁ encrypted with the public key pkC of client C as Enc_{pkC}(m₁). These are sent to mail server 1 (MS₁). In the next step, MS₁ forwards σ_{skS1} and Enc_{pkC}(m₁) on to C. The client verifies the signature of S1 at step 3 and decrypts the encrypted mail file at step 4. Then, at step 5, the client re-encrypts email m1 using an algorithm of the client's choice and at step 6, client C generates an OPE encrypted version of the date or another selected characteristic of the email, for example, the time stamp, sender name, etc. Finally, client C sends the re-encrypted email and the OPE encrypted characteristic Eₖ(m₁), O(date₁) to repository mail server MS_{R}. As noted above for FIG. 2, client C could also choose to rely on only the encrypted signature portion of the security features by executing the storing step 7 on mail server MS₁. Likewise, the embodiment of FIG. 3 may be used to provide security for email without the encrypted signature portion of the FIG. 2, if a repository server MSR different from the server MS1 is used, because it nullifies the possibility of performing a known-plaintext attack (as long as MS1 and MSR do not collude).

In step 8, client C is typically able to receive emails from any number of senders, represented as S₂. Each of these senders may interact with the same or different mail servers, represented as MS₂. Sender S₂ sends a signed, encrypted email σ_{skS2}, Enc_{pkC}(m₂) to mail server MS₂ similarly to sender S₁. MS₂ forwards it on to client C who processes it similarly to steps 3-6. Client C then stores Eₖ(m₂), O(date₂) in MS_{R}.

In another embodiment, the OPE algorithm is enhanced with the introduction of randomness. Deterministic encryption is traditionally viewed as necessarily insecure. However, due to functional requirements, OPE is defined to be deterministic. In some settings it is possible to introduce randomization to OPE, and trade some of the functionality for increased security.

Indeed, in a deterministic scheme, every encryption of a plaintext value x would be mapped to the same ciphertext y. Once the adversary decrypts y, all encryptions of x are uncovered. Not so when randomness is used for encryption; each probabilistic OPE encryption of x maps to a different yᵣ, and decryption of a particular yᵣ does not allow to have full confidence in decrypting all encryptions of x.

The tradeoff is that now, while

∀x₁, x₂εD₁, x₁<x₂ [symbol] POPE(x₁)<POPE(x₂),

the converse preserves the order in the less strict sense:

∀x₁, x₂εD₁, POPE(x₁)≦POPE(x₂) [symbol] x₁≦x₂.

There are two simple variants of adding randomness to OPE. The first idea is to artificially extend the size of the plaintext domain by first mapping (with order preservation) elements from the original domain to a larger domain, and then applying OPE from the bigger domain. The domain extension can be done, e.g. by appending n random bits to the bit representation of the elements of original domain. It is easy to see that this extension is order-preserving, and that it enjoys the POPE benefit described above.

The second approach is to build on a deterministic OPE, as follows. Set POPE(x) to be equal to a randomly chosen element from interval [OPE(x), . . . , OPE(x+1)]. Decryption in this case will be in generality more costly, and use several calls to OPE in a divide-and-conquer manner. This has the advantage that the attacker will not be able to strictly order the plaintexts corresponding to the ciphertexts he received so it makes chosen ciphertext attack more difficult.

Numerous alternative implementations of the present invention exist. While embodiments have been described with regard to a cloud-based webmail application, the inventive concepts could be used in any application that needs to achieve computation on encrypted client data, such as data storage, advertising and geolocation services.

The apparatus of FIGS. 2 and 3 in one example comprises a plurality of components such as one or more of electronic components, hardware components, and computer software components. A number of such components can be combined or divided in the apparatus. An example component of the apparatus employs and/or comprises a set and/or series of computer instructions written in or implemented with any of a number of programming languages, as will be appreciated by those skilled in the art.

The apparatus in one example employs one or more computer-readable signal-bearing media. The computer-readable signal-bearing media store software, firmware and/or assembly language for performing one or more portions of one or more implementations of the invention. The computer-readable signal-bearing medium for the apparatus in one example comprise one or more of a magnetic, electrical, optical, biological, and atomic data storage medium. For example, the computer-readable signal-bearing medium comprises floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. In a networked system having at least one server coupling a plurality of clients, a method of providing secure, searchable data storage on the network comprising the steps of:
receiving, by a client, an encrypted data file from a server associated with a first provider;
encrypting, by the client, at least one selected characteristic associated with the encrypted data file using an algorithm which allows computation on encrypted data; and
storing, by the client, the encrypted data file on a different server associated with a second provider that does not share stored data files with the first provider.

2. The method of claim 1 wherein the server associated with the first provider is a webmail server and the data file represents an email.

3. The method of claim 2 wherein the server associated with a first provider hosts a reception account used to relay public-key encrypted email from senders of email to the client.

4. The method of claim 3 further comprising the step of verifying, by the client, a signature in each email from a reception account, said signature requiring a private key of the sender of the email.

5. The method of claim 3 wherein the client receives email from a plurality of reception accounts hosted on one or more servers.

6. The method of claim 1 wherein during the encrypting step, the client uses an order preserving encryption (OPE) algorithm.

7. In a cloud computing system having a plurality of servers for controlling the exchange of email between clients over a network, a method of providing secure, searchable storage of email on the network comprising the steps of:
receiving, by a client, an encrypted email from a reception account hosted on a server associated with a first provider;
encrypting, by the client, at least one selected characteristic associated with the email using an algorithm which allows computation on encrypted data; and
storing, by the client, the encrypted email on a repository account hosted on a different server associated with a second provider that does not share stored data with the first provider.

8. The method of claim 7 further comprising the step of verifying, by the client, a signature in each email from a reception account, said signature requiring a private key of the sender of the email.

9. The method of claim 8 wherein client maintains a list of trusted sources of email and does not process email originating from a server hosting a reception account.

10. The method of claim 7 wherein one or more servers may provide reception accounts for the client.

11. The method of claim 7 wherein the client does not process emails to or from the repository account.

12. The method of claim 7 wherein the computerized system comprises a cloud computing system.

13. The method of claim 12 wherein the clients access the servers associated with the first and second providers by using a web browser application.

14. The method of claim 7 wherein during the encrypting step, the client uses an order preserving encryption (OPE) algorithm.

15. The method of claim 14 wherein the selected characteristic is represented by a number of bits and the OPE algorithm is randomized by adding n random bits to the number of bits of the selected characteristic before executing the OPE algorithm.

16. The method of claim 14 wherein the OPE algorithm is randomized by computing OPE of x and x+1 and returning a value chosen at random at each execution in the interval [OPE(x), OPE(x+1)[ as the output.

17. A computer program product comprising a non-transitory computer-readable signal-bearing media having computer usable program code stored therein, said computer program product comprising:
computer usable program code for receiving an encrypted data file from a server associated with a first provider;
computer usable program code for encrypting at least one selected characteristic of the encrypted data file using an algorithm which allows computation on encrypted data; and
computer usable program code for storing the encrypted data file on a different server associated with a second provider that does not share stored data files with the first provider.

18. The computer program product of claim 17 wherein the server associated with the first provider is a webmail server and the data file represents an email.

19. The computer program product of claim 18 wherein the server associated with a first provider hosts a reception account used to relay public-key encrypted email from senders of email to the client.

20. The computer program product of claim 19 further comprising computer usable program code for verifying, by the client, a signature in each email from a reception account, said signature comprising a private key of the sender of the email.

21. The computer program product of claim 19 wherein the client receives email from a plurality of reception accounts hosted on one or more servers.

22. The computer program product of claim 17 wherein the computer usable program code for encrypting uses an order preserving encryption (OPE) algorithm.
